(19) United States
(12) Patent Application Publication
(10) Pub. No.: US 2004/0169744 A1
(43) Pub. Date: Sep. 2, 2004

(54) Image-sensing device for auto-judging exposure time

(76) Inventors: Yu Te Lu, Hsin-Chu (TW); Yang Ni, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/622,733

(22) Filed: Jul. 21, 2003

(30) Foreign Application Priority Data
Feb. 27, 2003 (TW) 92104144

(51) Int. Cl. H04N 9/68

(52) U.S. Cl. 348/238

(57) ABSTRACT

The invention provides an image-sensing device for auto-judging exposure time, which includes a photoelectric sensing element, a measuring unit, and a row-column selector. The photoelectric sensing element is composed of a plurality of sensing units arranged in arrays to sense the light source and convert the sensed light energy into a current signal for outputting. Besides, a measuring unit is employed to measure the current signal and a corresponding exposure time is calculated according to the sensed current signal. Also, the row-column selector can divide the sensing units into several sections by setting up the row-column selector to select a specific section for highlight exposure. Therefore, not only can the invention instantly measure the sensed optical current sensed by the photoelectric sensing element to achieve the effect of auto-judging exposure time, but the invention also is selective in exposure, low in production cost and small in volume.

### BACKGROUND OF THE INVENTION

1. Field of the Invention

The invention relates to a semiconductor image sensor and, more particularly, to an image-sensing device having a build-in photoelectric measuring unit for auto-judging exposure time in real time.

2. Description of the Related Art

The Application Specific Integrated Circuit (ASIC) in an image-extracting device can be divided into two blocks depending on their different functions: the front end is an image sensor, and the back end is an image processing IC. The image sensor in the front end is responsible for converting light waves into current signals, whereas the image processing IC in the back end is responsible for processing signals and controlling peripheral devices, including focusing and exposure.

From the above description, it can be understood that a conventional metrology for exposure time is not generated from the internal of an image sensor but from an exposure-measuring device of an image processing IC in the back end, which can read out the image value of each pixel of a whole image and calculate the average brightness of the whole image to decide the exposure value. However, each pixel reading must be carried out in an order, and complicated calculations must be performed to obtain the exposure value. Therefore, it requires a long time to do all the calculations.

On the other hand, conventionally there is also another design that employs an external sensitizing device to assist exposure measurement. However, the optical focusing path of the external photosensitizing device is different from that of the image sensor; therefore, a deviation may occur in the measured exposure. Owing to the deviation, a calibration mechanism has to be added in to the device for supporting the processing. However, such measuring design is very complicated in its optical path design and high in production cost, which in turn will increase the price of the product.

To cope with the above problems, the invention provides an image-sensing device capable of judging exposure time automatically so that the exposure can be determined precisely and instantly.

### SUMMARY OF THE INVENTION

The first object of the invention is to provide an image-sensing device for auto-judging exposure time, wherein a measuring optical current unit is built in the image-sensing device in order that the optical current sensed by the photoelectric sensing element can be measured in real time to achieve auto-judging exposure time instantly as well as to determine the exposure rapidly and precisely.

The second object of the invention is to provide an image-sensing device for auto-judging exposure time capable of selecting a specific area for weighted judging exposure depending on the different environments to be photographed so as to provide a best exposure effect.

The third object of the invention is to provide an image-sensing device for auto-judging exposure time without additional optical circuit and optical device so as to lower the production cost as well as to minimize the volume of image-sensing device.

According to the invention, an image-sensing device for auto-judging exposure time includes a photoelectric sensing element that is composed of a plurality of sensing units arranged in arrays to sense the light source and convert the sensed light energy into a current signal for outputting; and a measuring unit for collecting and measuring the current signal as well as calculating the corresponding exposure time according to the measured current signals.

The objects and technical contents of the invention will be better understood through the description of the following embodiment with reference to the drawings.

### BRIEF DESCRIPTION OF THE DRAWINGS

FIG. 1 is a block schematic diagram showing the architecture of the invention.

FIG. 2 is a schematic diagram showing the detailed architecture of the invention.

FIG. 3 is a schematic diagram showing the photoelectric sensing element of the invention is divided into nine sections.

### DESCRIPTION OF THE PREFERRED EMBODIMENTS

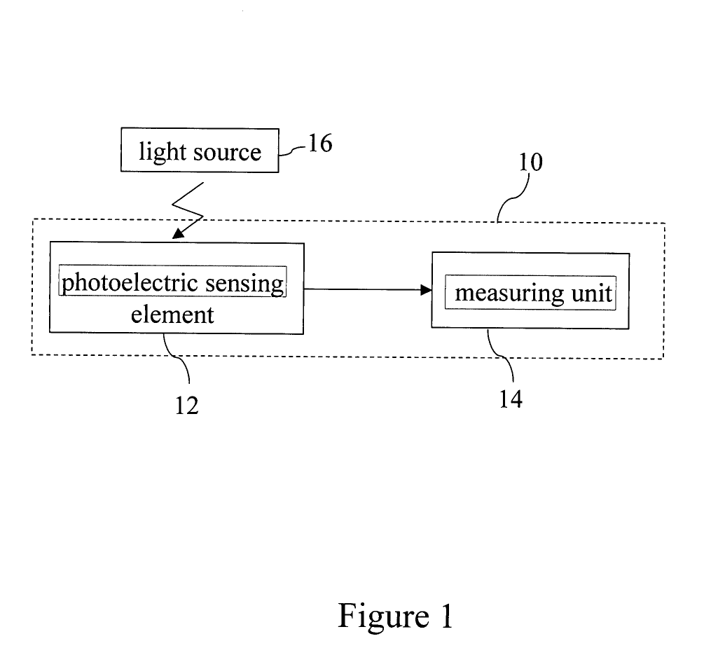

The principle of operating the image-sensing device for auto-judging exposure time of the invention can be understood with reference to FIG. 1, which is a block schematic diagram. As shown in FIG. 1, an image-sensing device 10 includes a photoelectric sensing element 12 and a measuring unit 14 connected to the photoelectric sensing element 12. The incident light wave from the light source 16 is sensed by the photoelectric sensing element 12 and then converted into a current. After that, the measuring unit 14 will collect the optical current sensed by the photoelectric sensing element 12 and measure it, and then calculate the corresponding exposure time.

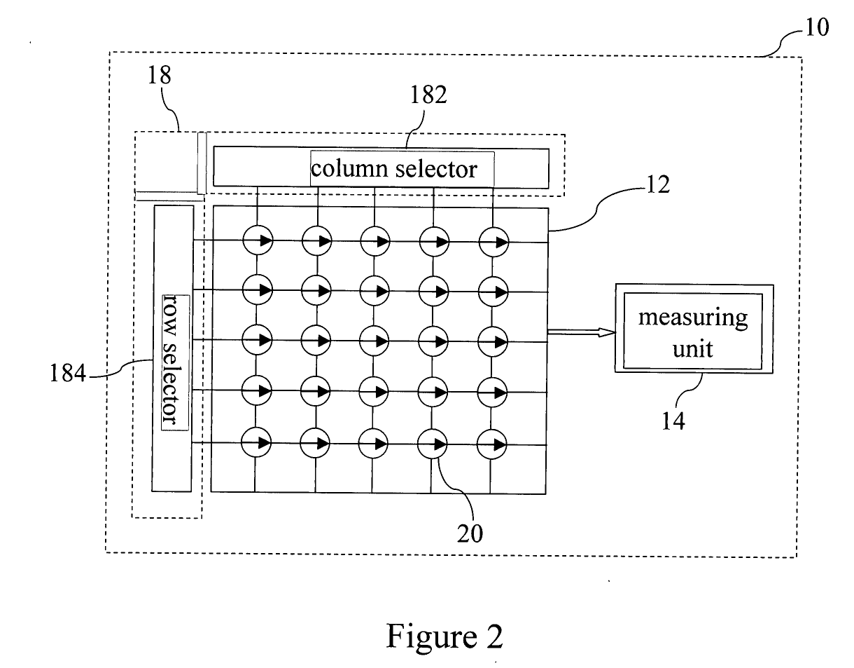

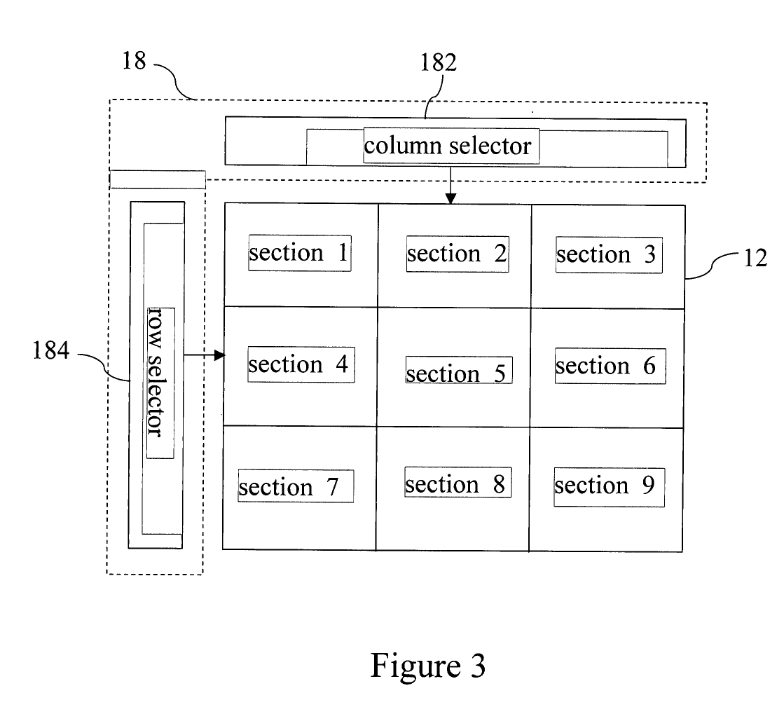

To further understand the operation relative to the detailed architecture of the image-sensing device 10, please refer to FIG. 2, which is a schematic diagram showing the detailed architecture of an embodiment of the invention. As shown in FIG. 2, an image-sensing device 10 includes a photoelectric sensing element 12 connected to a row-column selector 18 and a measuring unit 14. The photoelectric sensing element 12 consists of a plurality of sensing units 20 arranged in arrays. Each sensing unit 20 senses the light source and generates an electric charge in proportion to the incident light so as to convert the sensed light energy into current signal for outputting. The measuring unit 14 usually is a voltage/current comparator or other measuring device for measuring the magnitude of the current signal. The row-column selector 18 connected to the photoelectric sensing element 12 is composed of a column selector 182 and a row selector 184. Besides, the row-column selector 18 is also connected to a control circuit (not shown). The sensing units 20 inside the photoelectric sensing element 12 are divided into several sections, as shown in FIG. 3. Herein, the photoelectric sensing element 12 is divided into nine sections, and the specific section for highlight exposure can be selected by setting the row-column selector 18, while the control circuit will control the selected area to perform highlight exposure.

When the image-sensing device 10 is in operation, first, all the sensing units 18 inside the photoelectric sensing element 12 will be restored to their original electrical potentials. Next, after the light wave has been irradiated on the object to be photographed and has been reflected to the photoelectric sensing element 12, the sensing unit 20 in the photoelectric sensing element 12 will detect the incident light source and convert it into a current signal. Then, the row-column selector 18 that has been set up will selectively collect the current signal sensed by the sensing unit 20. After that, the measuring unit 12 will receive the current signal and calculate the corresponding exposure time in order to provide a basis for the exposure time to be carried out to the exposure control device. Finally, after the measuring unit 12 has done the measurement, it can be judged whether the sensed light is sufficient for the time being so as to accomplish deciding exposure time in real time.

In the invention, by integrating the photoelectric sensing element for sensing images into the measuring unit for judging exposure time as one device, the magnitude of the optical current sensed by the photoelectric sensing element can be measured instantly. Thus, auto-judging exposure time in real time as well as judging the exposure rapidly and precisely can be achieved altogether. Therefore, not only is the invention capable of resolving the problems and inconveniences caused by the conventional image-sensing device due to its incapability in judging the exposure time instantly and precisely, but the invention also is capable of selectively weighting judging exposure in accordance with different environments to be photographed so as to provide a best effect of exposure. In addition, since the invention can achieve auto-judging exposure time without additional optical circuit and optical device, the invention has the advantages of low in production cost and small in volume.

The embodiment above is only intended to illustrate the invention; it does not, however, to limit the invention to the specific embodiment. Accordingly, various modifications and changes may be made without departing from the spirit and scope of the invention as described in the appended claims.

What is claimed is:

1. An image-sensing device for auto-judging exposure time, including:
a photoelectric sensing element, which is composed of a plurality of sensing units arranged in arrays to sense the light source and convert the sensed light energy into current signal for outputting; and
a measuring unit, for measuring the current signal and calculating the corresponding exposure time according to the sensed current signal.

2. The image-sensing device for auto-judging exposure time as claimed in claim 1, wherein the measuring unit is a voltage/current comparator.

3. The image-sensing device for auto-judging exposure time as claimed in claim 1, further including a row-column selector to be set up so that the sensing units can be divided into several sections.

4. The image-sensing device for auto-judging exposure time as claimed in claim 3, wherein the row-column selector further provides selective sections for highlight exposure.

5. The image-sensing device for auto-judging exposure time as claimed in claim 3, wherein the row-column selector is further connected to a control circuit.

6. The image-sensing device for auto-judging exposure time as claimed in claim 3, wherein the row-column selector includes a row selector and a column selector.
